(19) United States
(12) Patent Application Publication
(10) Pub. No.: US 2012/0156465 A1
(43) Pub. Date: Jun. 21, 2012

(54) Ballistic Composites and Articles

(76) Inventor: Jamin Micarelli, Kirkland, WA (US)

(21) Appl. No.: 13/113,071

(22) Filed: May 22, 2011

Related U.S. Application Data
(60) Provisional application No. 61/348,220, filed on May 25, 2010.
(60) Provisional application No. 61/348,223, filed on May 25, 2010.
(60) Provisional application No. 61/348,226, filed on May 25, 2010.
(60) Provisional application No. 61/348,231, filed on May 25, 2010.

(51) Int. Cl. B32B 17/06; B32B 5/02

(52) U.S. Cl. 428/221

(57) ABSTRACT

A fiberglass composite improved with break layers spaced between the layers of fiberglass.

This application claims priority to the following four US Provisional Applications, all filed May 25, 2010: 61/348,220, 61/348,223, 61/348,226 and 61/348,231.

### TECHNICAL FIELD

The invention relates to the field of ballistic composites and articles made from ballistic composites; more particularly, it relates to methods and articles for ballistic fiberglass, ballistically optimized ceramics, a mid-core helmet and camouflage patterning on helmets.

### BACKGROUND OF THE INVENTION

### Ballistic Fiberglass

Fiberglass is a well known, extensively used, and inexpensive composite material. Fiberglass is strong, but is also heavy. Typical applications for fiberglass include boats and car parts due to the strength fiberglass offers. However, due to the weight, there are few practical applications for fiberglass other than floating or stationary objects, or motorized vehicles.

Fiberglass is typically layered in strips, and applied with some type of epoxy that gives rigidity. The strands of the fiberglass in conjunction with the epoxy create strength. However, the combination of the epoxy and fiberglass also makes a brittle composite that can withstand some impact, but generally fails or shatters once a failure point is reached.

### Ballistically Optimized Ceramics

Conventional methods of bonding or otherwise affixing or combining ballistic sheet material to ceramic plates relies on using low pressure and wrapping, such as in an autoclave or conventional vacuum bag press, because the conventional method of applying high pressure is a match die press. The brittle nature of the ceramic and the unforgiving application of force by a match die press generally create cracks and breaks in the ceramic, thus reducing or eliminating its ballistic effectiveness.

While the autoclave and/or vacuum bag press can reduce or eliminate the uneven pressure created by the match die press, they do not reach the necessary pressure required to optimize the applied ballistic sheets. Autoclave and vacuum bag products will be heavier than necessary because they can not be formed under appropriate high pressures.

An autoclave in general applies both heat and pressure to the workpiece placed inside of it. Typically, there are two classes of autoclave. Those pressurized with steam process workpieces which can withstand exposure to water, while the other class circulates heated gas to provide greater flexibility and control of the heating atmosphere.

Processing by autoclave is far more costly than oven heating and is therefore generally used only when isostatic pressure must be applied to a workpiece of comparatively complex shape. For smaller flat parts, heated presses offer much shorter cycle times. In other applications, the pressure is not required by the process but is integral with the use of steam, since steam temperature is directly related to steam pressure. Rubber vulcanizing exemplifies this category of autoclaving.

For exceptional requirements, such as the curing of ablative composite rocket engine nozzles and missile nosecones, a hydroclave can be used, but this entails extremely high equipment costs and elevated risks in operation. The hydroclave is pressurized with water (rather than steam); the pressure keeps the water in liquid phase despite the high temperature.

Hydroclaves in general use water as the pressurizing medium. Since the boiling point of water rises with pressure, the hydroclave can attain high temperatures without generating steam. While simple in principle, this brings complications. Substantial pumping capacity is needed, since even the slight compressibility of water means that the pressurization stores non-trivial energy. Seals that work reliably against air or another gas fail to work well with extremely hot water. Leaks behave differently in hydroclaves, as the leaking water flashes into steam, and this continues for as long as water remains in the vessel. For these and other reasons, very few manufacturers will consider making hydroclaves, and the prices of such machines reflect this.

What is needed is a new kind of press or pressure chamber where both heat and isostatic pressure can be applied to layered composites over comparatively complex shapes. We call such a press or pressure chamber a Boroclave. The Boroclave does not use water as a pressuring or pressure transfer medium. A Boroclave can be either oil or silicon filled, or a combination of both, with suitable separation materials.

### Mid-Core Helmet

Many ballistic helmets on the market today utilize a core ballistic material that is then hardened with an outer shell.

### Camouflage Patterning for Ballistic Surfaces

Conventional ballistic material and composite articles require very nearly smooth and or flat surfaces so that equal pressure is applied throughout the composite piece while it is being pressed. Any wrinkle or raised piece of material that placed or left in a workpiece offsets the pressure applied, and increases the pressure beneath the wrinkle, while correspondingly reducing it in other non-raised parts of the composite piece.

Alternatively, one can use a complex mold with the raised pattern carved into it, and then carefully fill it with material to fill the pattern, but the difficulty in ensuring that the ballistic composite receives the appropriate amount of pressure throughout the piece is still exceedingly difficult.

Breaking up or reducing light reflection from a surface is conventionally accomplished by using a wrinkling of the surface so that there are no large flat or smooth surfaces that reflect light in mostly one direction. This is also done as an add-on to articles after pressing, such as by covering the article with netting material.

Therefore, placing such raised, or three dimensional, patterns on a ballistic surface in conventional match die manufacturing requires an additional production step, thus increasing the time and cost of an article with molded-on patterning.

### DISCLOSURE OF THE INVENTION

### Ballistic Fiberglass

What is disclosed is method and articles for creating lightweight, ballistically enhanced, fiberglass parts. This is an enhancement for fiberglass that creates an inexpensive, portable ballistic material that can be carried by one person and used, for example, as a vest or helmet, but which can also be applied to traditional fiberglass uses, while adding significant ballistic and penetration protection.

Brittleness and shattering effects normally associated with fiberglass can be reduced or ameliorated by layering planned “break layers” throughout the layered composite.

In a normal fiberglass, the rigidity of the composite would prevent the deeper layers from being able to separately absorb the impact. Since all layers are so tightly bonded to each other, they are all shattered or at least weakened with the initial impact. The disclosed perforated plastic layers, or “breakaway layers,” significantly reduce bond strength from one set of composite layers to the next set, leaving subsequent sets of layers at relatively full strength, and retaining the ability to bend enough to increase the distance available to stop the projectile. A preferred material for these breakaway plastic layers is believed to be known in the industry as “peel ply fabric”.

### Ballistically Optimized Ceramics

This is a method and apparatus to bond ballistically optimized sheet material such as Dyneema HB 80 or Kevlar to brittle ceramic based armor.

What is disclosed is an enhancement for reducing the weight of ceramic based armor plates by employing the relatively high and omnidirectional pressure of a special Boroclave. The ceramic plate is protected from cracking by having isostatic pressure applied uniformly over the entire piece, while at the same time, the applied ballistic sheeting is heated and pressurized to a maximum performance level. By increasing the performance level of the applied ballistic sheeting, the over all weight of the armor composite piece can be reduced.

### Mid-Core Helmet

This is a method and apparatus for an improved ballistic helmet that is optimized to stop rifle rounds, high speed fragments, and reduce the backface signature of slow-speed hand gun rounds.

The disclosed helmet provides a hardened central (also referred to herein as mid or inner) core surrounded on both sides by ballistic material, that is then further protected by an outer shell. This “three-layer” system (ballistic—core—ballistic) provides improved ballistic protection by having an initial outer layer of ballistic material that is optimized for stopping relatively slow projectiles, such as 9 mm handgun rounds traveling at about 1400 feet per second, backed by a relatively more rigid central core that limits the backface travel of the outer layers of the helmet, thus protecting the wearers head from impact.

Most low velocity rounds will not penetrate the hardened central core. With higher velocity projectiles, the central core also acts to strip the copper shell from the heavy lead center of these higher velocity projectiles, such as 7.62 mm×39 mm AK 47 rounds traveling at 2400 feet per second. Once stripped of its copper shell, the projectile is flattened and stopped by the final, inner layers of ballistic material protection, designed to peel away from the central core with the deformed projectile emerging from the mid core. This effectively expands any potential impact area so that the projectile does not penetrate the wearer's head.

In addition to improved protection from the 9 mm threat and AK 47 threat, the placement of a central hardened core similarly increases effective ballistic performance on smaller, faster moving projectiles, such as 17 grain “fragment simulators” that are made of steel, and travel at above 3000 feet per second. The fast fragments are initially slowed by the outer layer, flattened by the hardened core, and then stopped by the final layer of ballistic material that is optimized for stopping fragments.

### Camouflage Patterning for Ballistic Surfaces

This is a method for creating camouflage patterns using three dimensional relief on ballistic surfaces to break up and reduce reflection, and therefore to increase the camouflage capacity of the surface; more particularly, a ballistic helmet that has integral broken reflective surfaces to reduce the reflective signature of the helmet.

The disclosed method provides a raised camouflage surface of ballistic material without having to add an additional production step. In a Boroclave press, a three dimensional pattern can advantageously be placed on any composite product without an additional pressing process. This is due to the omnidirectional pressure available in a Boroclave press that forms around the patterned material wherever it is placed.

In an example using multiple layers of ballistic material for a workpiece, a netting-like material is placed directly upon the layered material and covered with a layer of carbon sheeting, to which a hardening agent is added. The Boroclave will use its omnidirectional pressure to form the carbon sheet around the netting, while applying equal pressure throughout the ballistic sheets. The now raised portions of the carbon fiber eliminate any large reflective surfaces, thus significantly reducing the reflected light that can be observed from the ballistic piece.

By adding the integral broken reflective surface during the press cycle, the surface becomes part of the ballistic piece rather than simply added to the outside, and a step is removed from the process of making the surface less reflective. Patterns (netting) can be adjusted to optimize surfaces for refractive effect, or to increase uniformity while still having increased refractive ability.

### BRIEF DESCRIPTION OF THE DRAWINGS

FIGS. 1a&b are schematic diagrams of an aspect of an embodiment of the disclosure.

### BEST MODE OF CARRYING OUT THE INVENTION

Turning now to the drawings, a preferred embodiment is described by reference to the numerals of drawing figures, where applicable, wherein like numbers indicate like parts.

### Ballistic Fiberglass

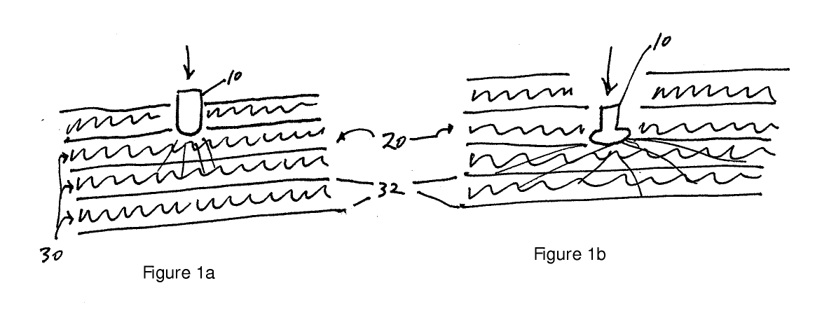

FIGS. 1a&b are schematic diagrams of an aspect of an embodiment of the disclosure. Ballistic composite 20 is made of sets of layers 30 of conventional fiberglass fabric, spaced apart by break layers 32. In FIG. 1a, projectile 10 passes through several fiberglass and break layer sets, but there is no shattering of the layers into which projectile 10 has not penetrated. FIG. 1b shows projectile 10 an instant later as it continues to penetrate additional fiberglass and break layer sets, again, with no shattering of the layers into which the projectile has not yet penetrated. Phantom force lines in each FIGURE are schematic non-quantitative representations of how the force of the impact is believed to be dispersed as the projectile moves into the composite, In FIG. 1a the lines are more narrow, more focused than in FIG. 1b, as the tip of the projectile is deformed and blunted by its interaction and passage through the layers of composite.

For example, in a 20 layer fiberglass epoxy composite, layers of perforated plastic are strategically placed to reduce the bond of the epoxy so that when an otherwise penetrating impact strikes the face of the fiberglass composite, complete failure of the fiberglass is prevented. It is believed that as the impact projectile penetrates further into the composite, the velocity of the projectile has time and space in which to dissipate its kinetic energy; at the same time, the transmitted kinetic energy from the impact travels only to the nearest breakaway layer, rather than shattering the entire composite.

For example, using a bullet as a test projectile, the initial speed and shape of the bullet striking the face of the fiberglass pierces a few of the initial layers. The force of the impact will deform the bullet enough to flatten the bullet tip, spreading the impact further through the composite. As the bullet continues to penetrate deeper layers of the composite, bullet velocity is further attenuated while, at the same time, the bullet tip/impact area that are sustaining the impact are both increasing.

### Example for a Fiberglass Ballistic Helmet:

Step 1: On a suitable helmet mold, stack 18 layers of standard E-Glass fiberglass that has been cut to 21 inches by 21 inch squares. After the first 3 layers, place a layer of perforated or breakaway plastic. Place 4 more E-glass layers, followed by another layer of breakaway plastic; then 4 more glass layers, and a breakaway layer, and repeat one more time. Finally, add 3 last layers of fiberglass.
Step 2: Infuse the stacked layers with a hardening agent, such as Smooth On product Task 9. This can alternately be performed as the layers are being put on the stack.
Step 3: Wrap the entire composite with another layer of breakaway plastic, and cover with a breathable, absorbent layer, such as felt.
Step 4: Place the entire product into a suitable heated high pressure composites press. Increase pressure to 1000 psi, reduce to 350 psi, and heat to 180 degrees for 30 minutes. After 30 minutes, cool the composite while maintaining pressure. Remove pressure, and then remove composite from the press. Remove excess material, and remove composite from mold.

This ballistic fiberglass helmet is lightweight and inexpensive compared to other ballistic helmets, and capable of stopping small arms threats up to 9 mm rounds traveling at 1400 feet per second. Selected levels of ballistic threat can be accommodated by either adding or removing layers to optimize for weight or ballistic protection. The cost of material is roughly 10% of other ballistic material, and though it will weigh more for comparable protection, it significantly reduces the costs required to provide protection.

Similarly, the disclosed method and material and fiber arrangement provide additional protection for blunt impact or slow moving impacts, such as boat hulls striking branches or stones. Where conventional fiberglass products would take the impact and either remain intact or fail, the disclosed material is adapted to take the full brunt of the impact on the initial layer, dissipate energy, and utilize subsequent breakaway layers to enable the hull to maintain water tight conditions, even against greater impacts.

### Ballistically Optimized Ceramics

### Example:

Step 1: to a base ceramic SAPI (Small Arms, Protective, Individual) plate, add 64 layers of Dyneema HB 80 on the back of the plate.
Step 2: Place the new composite ceramic and HB 80 piece in a Boroclave, surrounded by rubber molds made of Dragonskin Q and Rebound. Place a breathing layer like Kevlar 49 between the part and the mold, to facilitate trapped air escaping as pressure is applied.
Step 3: Close the Press lid on the mold wrapped composite: The entire mold presses into a base oil gasket which is made of Rebound, on top of oil contained in the Boroclave.
Step 4: Preheat the Boroclave to 255 degrees for 20 minutes.
Step 5: After temperature is held for 20 minutes, increase the pressure of the Boroclave to 3500 psi.
Step 6: Once at 3500 psi, decrease temperature to 50 degrees for 10 minutes.

### Step 7: Decrease psi to 0.

Step 8: Open press, remove part, trim excess material.

### Mid-Core Helmet

### Example: Making a Central Core Ballistic Helmet.

Step 1: using 32 layers of DSM Dyneema HB 80 ballistic sheets, preform a helmet shape in a standard match die press. This is done by preheating the material to approximately 250 degrees for 20 minutes, then placing the material on a female match die mold with a waffle pattern top, clamping the material to the female match die mold, and then passing the male portion of the mold through the material. The now formed portion of the helmet is allowed to cool, then removed from the mold and the excess material is removed. Step
2: place the composite on a male mold, and using 6 layers of Kevlar k49, place the k49 sheets on the preformed composite, using a hardening agent like Smooth-on product Task Nine. Cover the new composite with a breakaway layer and a breathable layer such as felt, and place the entire composite in a Boroclave. Run the Boroclave up to 1000 psi in order to ensure that all excess hardening agent is pressed out of the composite, and then reduce to 350 psi so that any excess air is able to escape through the breathable layer. Increase the temperature of the Boroclave to 180 degrees to increase the rate at which the hardening agent reacts and hardens. After approximately 30 minutes, reduce temperature, reduce pressure, and remove from the Boroclave, and remove excess material from composite.
Step 3: place 12 layers of DSM Dyneema HB 26 into an oven and preheat to 250 degrees for 20 minutes. Place the preheated layers onto a slightly larger female mold with waffle top, and clamp the material to the female mold. Place the previously made hb 80/k49 helmet core directly on the male mold, and then pass the male mold through the HB 26 layers into the female mold. Allow the HB 26 to cool, remove from mold, and then remove excess material.
Step 4: Take the new composite of hb 80, k49, and hb 26, and place it on a male post. Using two layers of carbon fiber and hardening agent like task 9, cover the helmet, place a breakaway layer and breathable felt layer over the composite, and place in Boroclave. Increase pressure to 1000 psi, reduce to 350 psi, and heat to 255 degrees for 20 minutes. Then increase the pressure to 4500 psi, and immediately cool the composite. Remove pressure, and then remove composite from Boroclave. Remove excess material from helmet.

### Camouflage Patterning for Ballistic Surfaces

Example: Making a Helmet with a Refractive Pattern.
Step 4: Take any composite preform helmet workpiece and place it on a male post. Place three dimensional pattern material, such as nylon netting, directly on the composite piece. Using an elastic restraining band to hold the material in place, arrange the pattern as desired (selectably varying regularity and symmetry of the netting openings). Using two layers of carbon fiber and hardening agent like Task 9, cover the helmet, place a breakaway layer and breathable felt layer over the composite, add an additional restraining band to hold all material in place, and then remove the first band so that it is not encased during processing. Place in Boroclave. Increase pressure to 1000 psi, reduce to 350 psi, and heat to 255 degrees for 20 minutes. Then increase the pressure to 4500 psi, and immediately cool the composite. (Pressures and temperatures may be varied to best suit the pressing requirements of the underlying helmet.) Remove pressure, and then remove composite from Boroclave. Remove excess material from helmet.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. In a fiberglass composite having fiberglass layers, the improvement comprising a plurality of break layers spaced between the layers of fiberglass.

2. The composite of claim 1, wherein the break layers occur every few layers of fiberglass.

3. A multi-layer fiberglass composite comprising, in stacked order: a break layer, a plurality of resin impregnated fiberglass layers, a break layer, and a plurality of resin impregnated fiberglass layers.
